(19) United States
(12) Patent Application Publication
(10) Pub. No.: US 2017/0223460 A1
(43) Pub. Date: Aug. 3, 2017

(54) MULTI-WAY EARPHONE

(71) Applicants: Hak Rae LEE, Gyeonggi-do (KR); An Seop CHO, Incheon (KR); Dong Hoon MIN, Gyeonggi-do (KR)

(72) Inventors: Hak Rae LEE, Gyeonggi-do (KR); An Seop CHO, Incheon (KR); Dong Hoon MIN, Gyeonggi-do (KR)

(21) Appl. No.: 15/329,238

(22) PCT Filed: Jul. 31, 2014
(86) PCT No.: PCT/KR2014/007031

§ 371 Date: Jan. 25, 2017

(51) Int. Cl. H04R 5/033; H04R 1/24; H04R 1/10

(52) U.S. Cl. CPC H04R 5/033; H04R 1/1016; H04R 1/24; H04R 1/1058

(57) ABSTRACT

A multi-way earphone may include: a housing having a space therein; a first sound unit housed in the space of the housing, and configured to convert an electrical signal into a sound; and a second sound unit disposed in a vertical direction from the first sound unit, and configured to output a different range of sound from the sound outputted from the first sound unit. The housing may form a first transmission path through which the sound outputted from the first sound unit is transmitted to the outside along the inner circumferential surface of the housing, and the second sound unit may include a unit cap forming a second transmission path through which the sound outputted from the second sound unit is outputted while being separated from the sound passing through the first transmission path.

The stereo performance of the multi-way earphone can be improved to provide a sound with a 3D effect to a listener.

### TECHNICAL FIELD

The present disclosure relates to a multi-way earphone.

### BACKGROUND ART

In general, an earphone refers to a small-sized sound reproduction device which is worn in a user's ear, and outputs a sound in each frequency range depending on a speaker mounted in a housing.

Recently, with the rapid development of earphone technology, there has been an earphone which outputs sounds in different ranges, in order to improve the stereo performance. Korean Patent No. 10-1116981 (hereafter, referred to as ‘related art’) has disclosed a coaxial earphone that generates sounds in different reproduction ranges.

However, the earphone according to the related art has a structure in which a high range of sound is outputted from one side thereof and simultaneously mixed with a low range of sound outputted from the other side thereof, and the sound mixed in the housing is outputted to the outside. Thus, there is a demand for the development of a new earphone for providing a sound with a three-dimensional effect to a listener.

### DISCLOSURE

### Technical Problem

Various embodiments are directed to an earphone which exhibits an enhanced stereo performance, compared to the conventional earphone.

The purpose of the present invention is not limited, but other purposes of the present invention will be able to be clearly understood by those skilled in the art, based on the following descriptions.

### Technical Solution

In an embodiment, a multi-way earphone may include: a housing having a space therein; a first sound unit housed in the space of the housing, and configured to convert an electrical signal into a sound; and a second sound unit disposed in a vertical direction from the first sound unit, and configured to output a different range of sound from that of the sound outputted from the first sound unit. The housing may form a first transmission path through which the sound outputted from the first sound unit is transmitted to the outside along the inner circumferential surface of the housing, and the second sound unit may include a unit cap forming a second transmission path through which the sound outputted from the second sound unit is outputted while being separated from the sound passing through the first transmission path.

The housing may include an upper body housing an upper part of the first sound unit and a lower body supporting the first sound unit from the bottom of the first sound unit.

The first transmission path may be formed by a gap between the inner circumferential surface of the lower body and the outer circumferential surface of the second sound unit.

The lower body may have a plurality of fixing members formed on the inner circumferential surface thereof and protruding to fix the second sound unit, and the plurality of fixing units may be separated from each other such that a space formed among the plurality of fixing units constitutes a part of the first transmission path.

The first sound unit may output a bass-to-mid range of sound or a high range of sound.

### Advantageous Effects

According to the embodiment of the present invention, the multi-way earphone can output different ranges of sounds through the first and second transmission paths formed in the lower body of the housing such that the sounds are separated and outputted to a listener's ears. Thus, the stereo performance can be improved to provide a sound with a 3D effect to the listener.

The effects of the present invention are not limited thereto, but other effects can be clearly understood by those skilled in the art, based on the descriptions of claims.

### BRIEF DESCRIPTION OF DRAWINGS

FIG. 1 is a side view of a multi-way earphone according to an embodiment of the present invention.

FIG. 2 is an exploded perspective view of the multi-way earphone according to the embodiment of the present invention.

FIG. 3 is a perspective view of the multi-way earphone according to the embodiment of the present invention.

FIG. 4 is a cross-sectional view taken along the line B-B′ of FIG. 3.

FIG. 5 is a cross-sectional view taken along the line A-A′ of FIG. 3.

FIG. 6 schematically illustrates a state in which a lower body, an ear tip and a second sound unit are coupled according to the embodiment of the present invention.

### MODE FOR INVENTION

Hereafter, exemplary embodiments of the present invention will be described in detail with reference to the accompanying drawings, and publicly known techniques will be omitted to simplify the description.

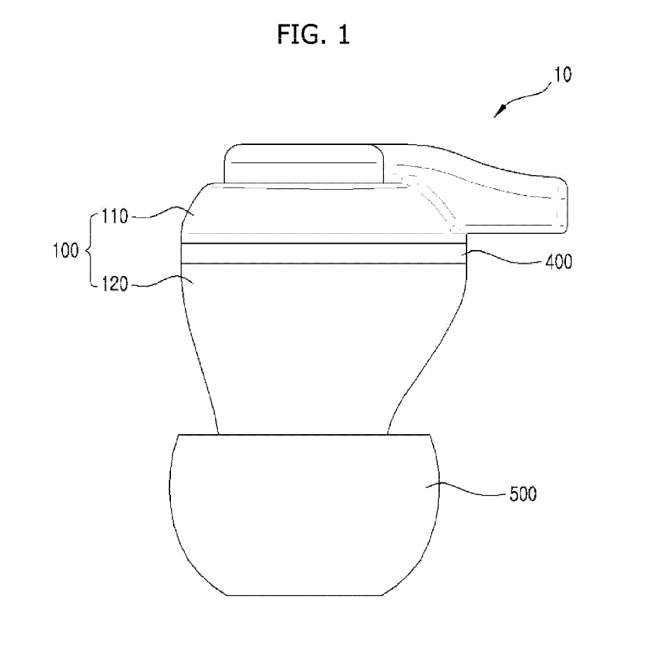

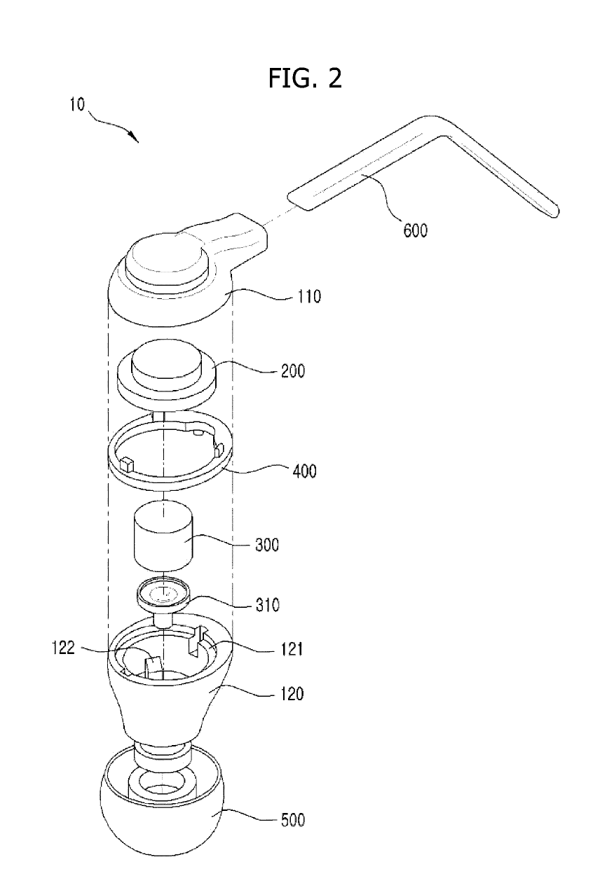

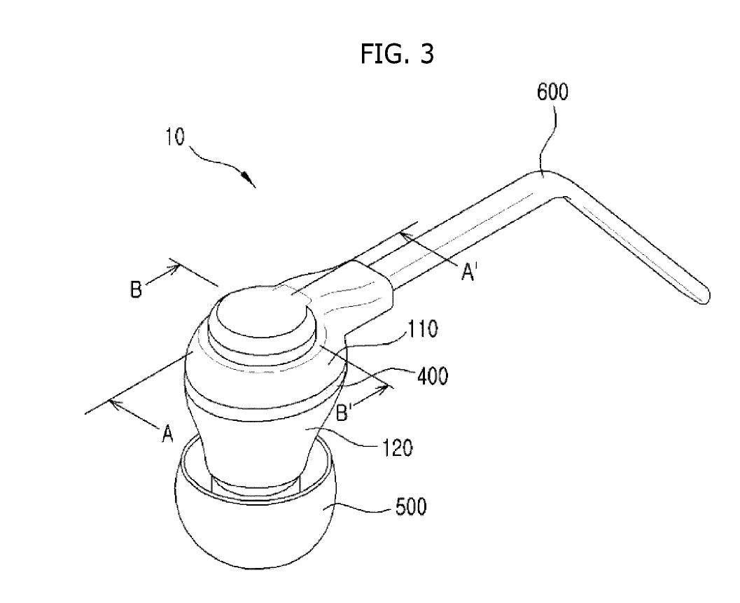

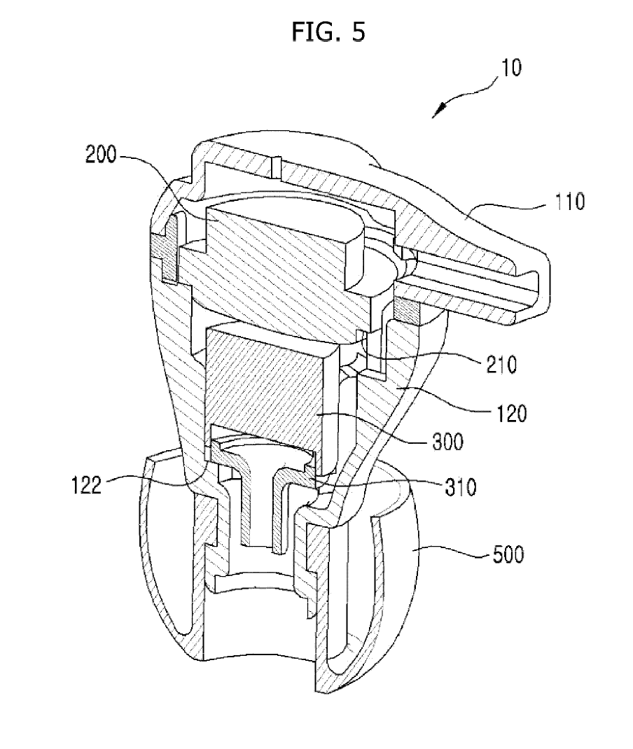

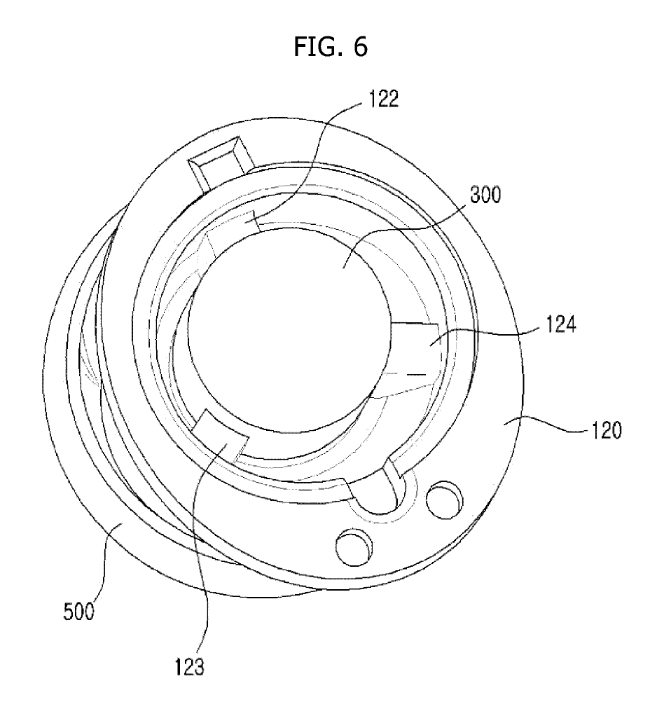

A multi-way earphone 10 according to an embodiment of the present invention may include a housing 100, a first sound unit 200, a second sound unit 300, a coupling ring 400, an ear tip 500 and a cable 600, and will be described with reference to FIGS. 1 to 6.

The housing 100 may have a space for housing the parts constituting the multi-way earphone 10, and include an upper body 110 and a lower body 120. The upper body 110 houses an upper part of the first sound unit 200, and has a cable connection hole (not illustrated) formed at one side thereof. The cable 600 is inserted into the upper body 110 through the cable connection hole.

The lower body 120 is positioned under the upper body 110, and supports the first sound unit 200 from the bottom of the first sound unit 200. That is, the lower body 120 has a stepped portion 121 formed along the inner circumference thereof, and the first sound unit 200 has a stepped structure 210 formed at one side thereof, the stepped structure 210 corresponding to the stepped portion 121. Thus, the first sound unit may be seated and fixed onto the stepped portion 121.

Furthermore, the lower body 120 has a plurality of fixing members 122, 123 and 124 formed on the inner circumferential surface thereof, the fixing members 122, 123 and 124 protruding to fix the second sound unit 300. The plurality of fixing members 122, 123 and 124 are separated from each other while being arranged along the inner circumference of the lower body 120. Thus, a predetermined space is formed among the plurality of fixing members 122, 123 and 124.

That is, the space formed among the plurality of fixing members 122, 123 and 124 constitutes a part of a first transmission path 130 through which a sound outputted from the first sound unit 200 is transmitted, and will be described in detail later.

Between the upper body 110 and the lower body 120, the coupling ring 400 may be located to couple the respective bodies. In an embodiment, the upper body 110 and the lower body 120 may be coupled to the coupling ring 400 with an adhesive.

The first sound unit 200 is seated on the stepped portion 121 of the lower body 120 and housed in the lower body 120, and functions as a sound device that converts an electrical signal into a sound.

The first sound unit 200 may output a bass-to-mid range of sound or high range of sound depending on an embodiment. In an embodiment, when the first sound unit 200 outputs a bass-to-mid range of sound, the first sound unit 200 may have a larger diameter than the second sound unit 300 outputting a high range of sound, which is desirable in terms of output efficiency.

The second sound unit 300 is disposed so as to be separated from the first sound unit 200 in the vertical direction, and outputs a sound in a different range from the sound outputted by the first sound unit 200. As described above, when the first sound unit 200 outputs a bass-to-mid range of sound, the second sound unit 300 outputs a high range of sound. In an embodiment, the first and second sound units 200 and 300 may include a dynamic driver.

The housing 100 forms the first transmission path 130 through which a sound outputted from the first sound unit 200 is transmitted to the outside along the inner circumferential surface of the housing 100. In an embodiment, the first transmission path 130 may be formed by a gap between the inner circumferential surface of the lower body 120 and the outer circumferential surface of the second sound unit 300.

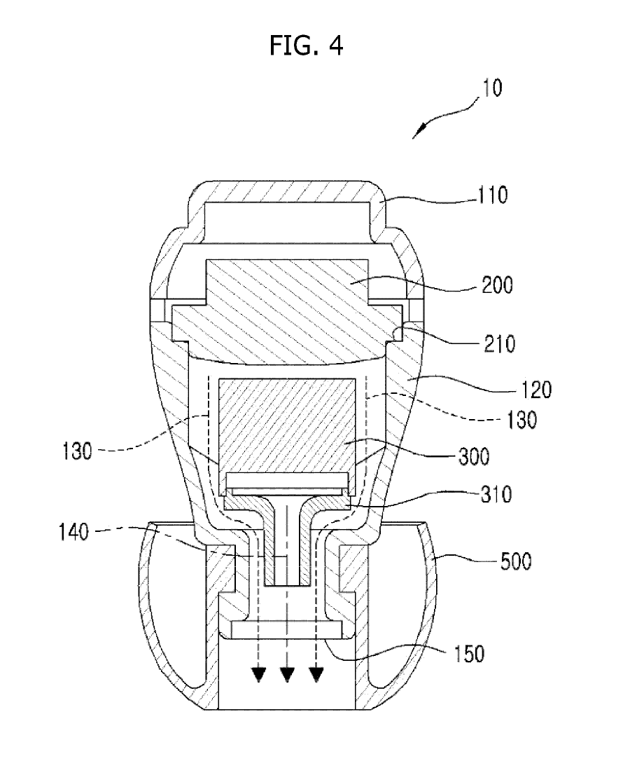

The first transmission path 130 and a second transmission path 140 according to the present embodiment may be formed in the lower body 120. For convenience of description, as illustrated in FIG. 4, a space through which the sound outputted from the first sound unit 200 is transmitted may be referred to as the first transmission path 130, and a space through which the sound outputted from the second sound unit 300 is transmitted may be referred to as the second transmission path 140.

The second sound unit 300 may be coupled with a unit cap 310 at one side thereof, and a space through which the sound outputted from the second sound unit 300 is transmitted is formed. That is, the unit cap 310 may form the second transmission path 130 through which the sound outputted from the second sound unit 300 is outputted while being separated from the sound passing through the first transmission path 130. The unit cap 310 let the sound outputted from the second sound unit 300 be transmitted toward the ear tip 500 from the lower body 120.

The length of the unit cap 310 may be adjusted to isolate the end of the unit cap 310 from a sound output port 150 toward inside of the lower body 120, thereby providing a space to accommodate a wire mesh (not illustrated) that prevents foreign matters from being introduced into the lower body 120 through the sound output port 150. Depending on an embodiment, the end of the unit cap 310 can be extended to the sound output port 150 such that the sound passing through the second transmission path 140 is separated from the sound passing through the first transmission path 130.

The ear tip 500 may be made of silicone rubber for giving comfort to a user. However, the ear tip 500 may be made of any materials if they can be smoothly worn.

A circuit board (not illustrated) may be positioned at the top of the first sound unit 200. One side of the circuit board may be connected in parallel to the first and second sound units 200 and 300, and the other side of the circuit board may be connected to the cable 600 and supply an electrical signal and power required for sound output.

The process in which the sounds outputted from the first and second sound units 200 and 300 are transmitted along the first and second transmission paths 130 and 140 and discharged to the outside will be described with reference to FIG. 4.

The bass-to-mid range of sound outputted from the first sound unit 200 is transmitted toward the bottom of the lower body 120 along the space formed between the inner circumferential surface of the lower body 120 and the outer circumferential surface of the second sound unit 300 (that is, the first transmission path 130). Then, the bass-to-mid range of sound is transmitted toward the sound output port 150 through the space formed among the plurality of fixing members 122, 123 and 124, and outputted to the outside.

While the bass-to-mid range of sound is outputted from the first sound unit 200, a high range of sound is outputted from the second sound unit 300 at the same time. That is, the high range of sound is transmitted to the outside through the second transmission path 140 in the unit cap 310 from the second sound unit 300. Thus, the high range of sound is not mixed with the bass-to-mid range of sound, but transmitted toward the sound output port 150 and outputted to the outside, while being separated from the bass-to-mid range of sound.

Thus, the multi-way earphone according to the present embodiment can output sounds in different ranges through the first transmission path 130 formed in the lower body 120 of the housing 100 and the second transmission path 140 formed by the unit cap 310, while separating the sounds from each other. Therefore, the stereo performance can be improved to provide a sound with a 3D effect to a listener.

While various embodiments have been described above, it will be understood to those skilled in the art that the embodiments described are by way of example only. Accordingly, the scope of present invention should not be limited by the embodiments described herein.

### SHORT EXPLANATIONS FOR REFERENCE NUMERALS

10: Multi-way earphone

100: Housing

110: Upper body

120: Lower body

121: Stepped portion

122, 123, 124: Fixing member

130: First transmission path

140: Second transmission path

150: Sound output port

200: First sound unit

210: Stepped structure

300: Second sound unit

310: Unit cap

400: Coupling ring

500: Ear tip

600: Cable

1. A multi-way earphone comprising:
a housing having a space therein;
a first sound unit housed in the space of the housing, and configured to convert an electrical signal into a sound; and
a second sound unit disposed in a vertical direction from the first sound unit, and configured to output a different range of sound from that of the sound outputted from the first sound unit,
wherein the housing forms a first transmission path through which the sound outputted from the first sound unit is transmitted to the outside along the inner circumferential surface of the housing,
the second sound unit comprises a unit cap forming a second transmission path through which the sound outputted from the second sound unit is outputted while being separated from the sound passing through the first transmission path,
both of the first and second sound units comprise a dynamic driver, and
the housing comprises: an upper body housing an upper part of the first sound unit; and a lower body supporting the first sound unit from the bottom of the first sound unit,
wherein the lower body has a stepped portion formed along the inner circumference thereof, the first sound unit is seated on the stepped portion, the first transmission path is formed by a gap between the inner circumferential surface of the lower body and the outer circumferential surface of the second sound unit, the lower body has a plurality of fixing members formed on the inner circumferential surface thereof and protruding to fix the second sound unit, and the plurality of fixing units are separated from each other such that a space formed among the plurality of fixing units constitutes a part of the first transmission path.

2. The multi-way earphone of claim 1, wherein the first sound unit outputs a bass-to-mid range of sound or high range of sound.
